(19) United States
(12) Patent Application Publication
(10) Pub. No.: US 2009/0092460 A1
(43) Pub. Date: Apr. 9, 2009

(54) FASTENER HAVING FLEXIBLY FIRM BRISTLES

(76) Inventor: John Langis, Standish, ME (US)

Correspondence Address: CHRIS A. CASEIRO, VERRILL DANA, LLP, ONE PORTLAND SQUARE, PORTLAND, ME, 04112-0586, US

(21) Appl. No.: 11/608,446

(22) Filed: Dec. 8, 2006

Related U.S. Application Data
(60) Provisional application No. 60/749,852, filed on Dec. 13, 2005.

(51) Int. Cl. F16B 35/04

(52) U.S. Cl. 411/107

(57) ABSTRACT

A fastener having a plurality of flexibly firm bristles. The fastener includes a substantially linear primary attachment member, such as a bolt, for example, and a plurality of flexibly firm bristles connected to the substantially linear member. When the fastener is inserted into a hole, friction between the plurality of flexibly firm bristles and the inner circumference of the hole secures the fastener within the hole. Since the plurality of flexibly firm bristles are flexible, they are insertable into any one of a plurality of holes which collectively have a wide range of inner circumferences. The fastener is especially useful for securing heavy objects, such as a large sign, to a stationary support member, such as a side of a building. The fastener is also useful for securing objects to a stationary support member that does not allow, or does not easily allow, holes to be drill entirely therethrough, such as a brick wall, for example.

### CROSS REFERENCE TO RELATED APPLICATION

The present application claims the priority benefit of U.S. provisional patent application Ser. No. 60/749,852, filed Dec. 13, 2005, entitled “FASTENER HAVING FLEXIBLY FIRM BRISTLES” of the same named inventor. The entire contents of that prior application are incorporated herein by reference.

### BACKGROUND OF THE INVENTION

1. Field of the Invention

The present invention relates to a fastener, and more specifically to a fastener which can be secured quickly, easily and firmly within a wide range of hole inner circumferences, and within holes that do not extend through a wall or other structure to which the fastener is to be secured.

2. Description of the Prior Art

People have fastened a variety of objects, such as signs, picture frames, bookshelves, mailboxes, etc., to the walls of buildings for as long as buildings have existed. In some cases, this involves having to secure a fastener within a hole having an inner circumference that is substantially different than the outer circumference of the fastener. For example, to hang a sign or an individual sign letter, those in the sign installation field commonly drill holes, fill each hole with glue, insert a fastener having an outer circumference that is smaller than is the inner circumference of the hole into each glue-filled hole, allow the glue to dry completely, and then affix the sign to the portion of the fastener protruding from the wall. A significant drawback to this gluing method is that much time is required to fill each hole with glue and to allow the glue to dry.

Despite its substantial time requirement, however, the gluing method often is the method of choice because existing alternative means for fastening signs to buildings are even more inadequate. One reason why this is true is that most existing fasteners are not designed to fit securely within a wide range of hole inner circumferences. One class of such fasteners are those having a shaft which features a plurality of inflexible, or essentially inflexible, ribs or similar protuberances. For example, U.S. Pat. No. 6,520,704 issued to Vidmar et al. discloses a pin having a resilient gripper projection. The resilient gripper projection portion of the pin is designed to deform slightly as it passes into a hole, thereby allowing the pin to be secured within the hole. Fasteners having inflexible, or essentially inflexible, protuberances, such as the Vidmar et al. device, are not preferred over the gluing method for at least one significant reason, which is that they can be fit only within holes having inner circumferences that are of the same or are of a slightly smaller size as the circumference of the fastener.

A second class of fasteners are those having a shaft which features a plurality of flexible members which protrude from the shaft. While these fasteners can be fit securely within a greater range of inner hole circumferences than can those having a plurality of inflexible, or essentially inflexible, ribs or similar protuberances, they have other significant limitations. For example, U.S. Pat. No. 4,083,162 issued to Regan et al. discloses a fastening assembly having a plurality of resilient splines which extend angularly outward and away from the end of the assembly that is to be fastened through a hole. The Regan et al. device is limited, however, in that its design does not allow it to be secured within a hole that is not completely recessed through the structure to which the end containing the flexible members is to be secured. Therefore, the Regan et al. device cannot be used when drilling a hole entirely through the surface of a wall or like-structure is undesirable or impractical, such as when a sign is to be secured to the thick outer wall of a building.

Another device belonging to this second class of fasteners is described in U.S. Pat. No. 4,859,127 issued to Koch. The Koch device has two ends; at one end of the device is a coiled spring wire device attached to and extending outward from the head of a bolt, and at the other end of the device is a threaded region of the bolt. A significant drawback to the Koch device is that it only will fit within a hole having an inner circumference slightly larger than the outside circumference of the device.

Additionally, U.S. Pat. No. 4,633,640 issued to Hutter discloses a wall anchor or support with a shank portion having a plurality of spaced triangular-shaped members, which are designed to make contact with the inner surface of the hole into which the shank is inserted. A limiting feature of the Hutter device is that only the rounded portions of its triangular-shaped members actually contact the inner circumference of the hole within which they are inserted, and therefore the triangular-shaped members do not optimally grip the inner surface of the hole. For this reason, it does not appear that the Hutter device would be optimally suited for securing a heavy object to a support member; a heavy object, due to its weight, would be apt to pull away from the support member and optimal resistance to such pulling would require the use of a fastener having substantially more gripping ability than does the Hutter device. Similarly, the Hutter device is not optimally designed to secure a light object. Wind striking a small sign or a bookshelf being tugged on during dusting or other normal use can cause those objects over time to become detached from a wall or surface. Securing objects more firmly than the Hutter device allows thus would retard the rate of detachment or prevent it altogether.

Therefore, what is needed is a fastener for mounting objects which can be secured quickly, easily, and firmly within a wide range of inner hole circumferences, and within holes that do not extend through the wall or other structure to which the object is to be mounted.

### SUMMARY OF THE INVENTION

It is an object of the present invention to provide a fastener which can be secured quickly, easily and firmly within a wide range of inner hole circumferences, and within a hole that does not extend though the wall or structure to which the fastener is to be secured. Generally, the fastener of the present invention features a substantially linear primary attachment member having two sections, the first section of which is threaded and optionally bears one or more fixed or removable nuts or equivalent retaining devices, and the second section of which includes a plurality of flexibly firm bristles. The second section of the fastener is intended to be inserted into a hole such that the flexibly firm bristles are contained entirely within the hole, the exposed ends of some of the flexibly firm bristles grip the inner circumference of the hole, and the first section of the fastener extends outward from the hole. The contact between the flexibly firm bristle ends and the inner circumference of the hole serves advantageously to help firmly secure the fastener within the hole. Also helping to keep the fastener firmly secure within the hole is the collective mass of the flexibly firm bristles, which preferably become flexed upon entering the hole. In this arrangement, it therefore is required that the diameter of the fastener from the center of the bolt or similar device to the ends of the flexibly firm bristles that are not connected to the fastener be larger than the diameter of the hole from its center to its side walls.

In one aspect of the invention, the first section of the fastener does not extend through the face of the object, such as a sign, which it fastens to a stationary support structure, such as a wall, but instead is secured within the body of the object.

In another aspect of the invention, the first section of the fastener does extend through the face of the object, such as a sign, which it fastens to a stationary support structure, such as a wall.

In another aspect of the invention, multiple fasteners embedded into a stationary support structure, such as a wall, collectively serve to secure an object, such as a sign, to the stationary support structure by first securing the first section of each fastener through the back of the object and within its body, but without extending the first section of each fastener through the face of the object.

In another aspect of the invention, multiple fasteners embedded into a stationary support structure, such as a wall, collectively serve to secure an object, such as a sign, to the stationary support structure by first passing the first section of each fastener through respective openings cut out of the object, and then by securing a nut onto the threaded portion of the first section of each fastener.

In another aspect of the invention, no nut is threaded onto the threaded portion of the first section of the fastener.

In another aspect of the invention, a lightweight object is secured to a stationary support structure by using only a single fastener.

These and other features and advantages of the invention will be apparent upon review of the following detailed description and accompanying claims.

### BRIEF DESCRIPTION OF THE DRAWINGS

FIG. 1 is a side elevation view of the fastener with flexibly firm bristles according to the preferred embodiment of the present invention.

FIG. 2 is a simple side representation of the fastener securing an individual sign letter to a stationary support structure, in which the fastener protrudes through the face of the individual sign letter.

FIG. 3 is a front view of multiple individual sign letters secured to the face of a stationary support structure by multiple fasteners.

FIG. 4 is a simple representation of the fastener securing an individual sign letter to a stationary support structure, in which the fastener does not protrude through the face of the individual sign letter, but instead extends through the back of the individual sign letter and secured within its body.

FIG. 5 is a simple side representation of the fastener securing a box member to a stationary support structure, in which the fastener includes two stop nuts for securing the box member to the support structure.

FIG. 6 is a detailed side view of the fastener after being inserted into a hole in a stationary support structure.

FIG. 7 is a magnified view of the fastener of FIG. 6 focusing on the contact being made between the flexibly firm bristles of the fastener and the inner surface of the hole.

### DETAILED DESCRIPTION OF THE PREFERRED EMBODIMENTS OF THE INVENTION

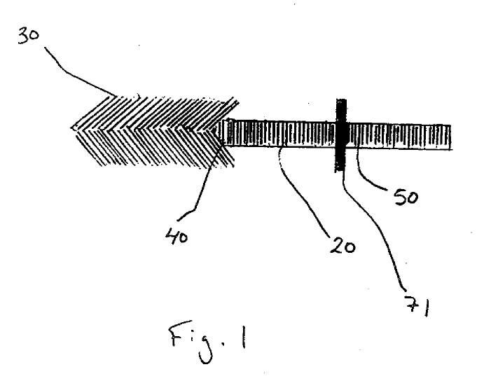

A fastener 10 featuring a substantially linear primary attachment member shown as a bolt 20 and a plurality of flexibly firm bristles 30 is shown in FIG. 1. Alternatively, the primary attachment member may instead be any substantially linear member, such as a shaft, shank, stud, pin, peg, rod, dowel, bar, for example. The bolt 20 includes a first section 60 and a second section 40. At its first section 60, the bolt 20 includes means to removably retain the primary attachment member in a selectable position, such as threading 50. The fastener 10 includes one or more optional threaded stop nuts 71 for fastening to the threading 50 of the bolt 20. The bristles 30 are located at the second section 40.

The bolt 20 and the plurality of flexibly firm bristles 30 are either made from the same material or are made from different materials. The bristles 30 are firm enough to secure the fastener 10 within a hole, and are flexible enough to secure the fastener 10 within holes of varied circumferences all the while allowing the bristles 30 to maintain contact with the inner walls of the hole. In the preferred embodiment, both the bolt 20 and the plurality of flexibly firm bristles 30 are fabricated of a non-metallic material such as plastic or a plastic composite, and more particularly, a high-density polyethylene. In another embodiment, both the bolt 20 and the plurality of flexibly firm bristles 30 are fabricated of a metal or a metal alloy, such as stainless steel. The exact nature of the material used may or may not be critical to any particular use of the fastener 10. For example, if the fastener 10 is to be used outdoors, it might be important that it be made from a metal or plastic that will be able to withstand deterioration caused by rain, snow, sun, etc. For applications not requiring that the fastener 10 be made of any particular material, the fastener 10 may be selected solely on the basis of cost or availability.

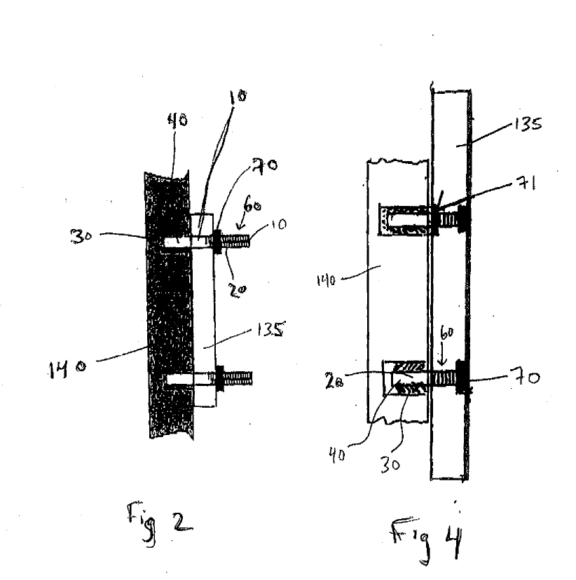

In FIG. 2, the fastener 10 is shown securing an individual sign letter 135 to a stationary support structure 140. FIG. 3 shows a front view of multiple individual sign letters 135-137 secured to the stationary support structure 140 by fasteners 10 such that the multiple individual sign letters 135-137 form, for example, a company logo. In the embodiment shown in FIG. 2, the threading 50 of the first section 60 of the bolt 20 extends through the face of the individual sign letter 135 and a nut 70 is threaded onto the threading 50 of first section 60 of the bolt 20 to secure the individual sign letter 135 to the fastener 10. Another example of this embodiment is shown in FIG. 3, wherein individual sign letter 135, specifically the letter “A” in the drawing, is shown secured to the face of the stationary support structure 140 using multiple fasteners 10 such that the first section 60 of each fastener 10 and the nut 70 threaded onto the first section 60 of each fastener 10 is visible on the face of the individual sign letter 135. While FIG. 3 specifically shows an individual sign letter 135 being held onto the surface of a building by the fastener 10, the fastener 10 may be used to fasten objects which are not individual sign letters 135-137 to any stationary support structure 140 suitable for holding such objects. For example, these objects include, but are not limited to being, signs, plaques, mailboxes, shelves, picture frames, artwork, decorations, bathroom tissue holders, mirrors, coat racks, wine racks, flat screen television wall brackets, home entertainment stereo speaker brackets, and the like.

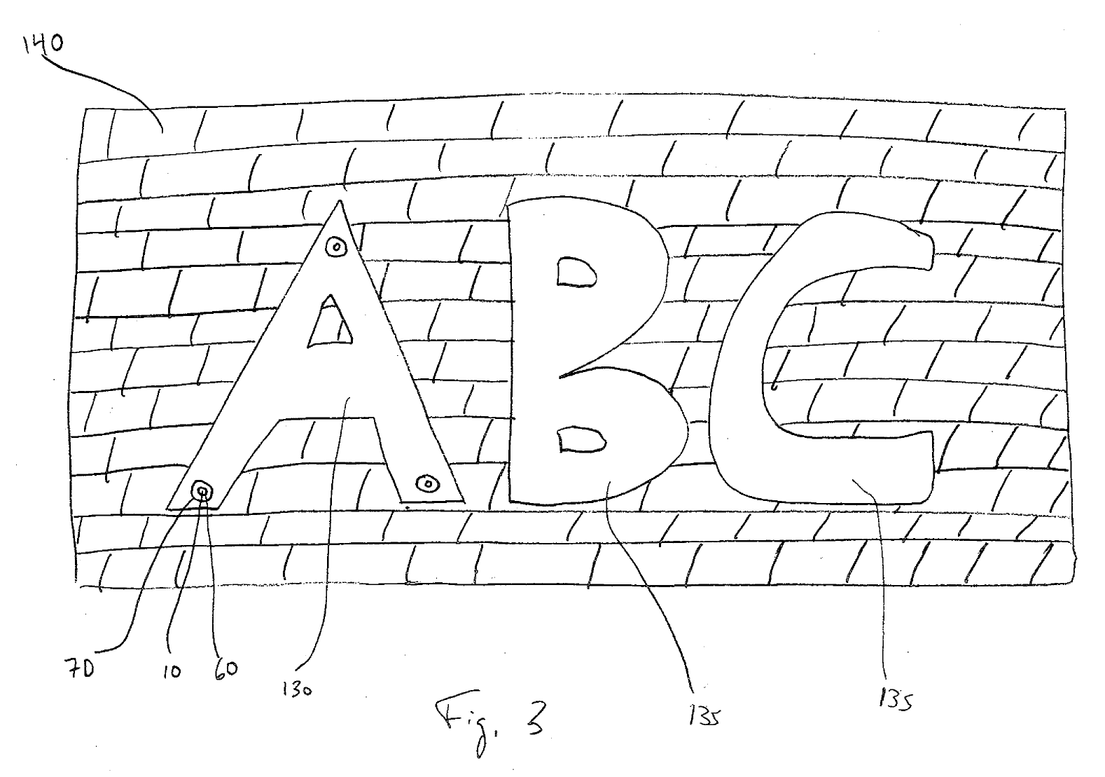

In another embodiment of the invention, which is shown in FIG. 4, the nut 70 affixed to the end of the first section 60 of the fastener 10 is secured within the body of individual sign letter 135 by welding, gluing or by another suitable securing means. The optional threaded stop nut 71 affixed to a more central region of the first section 60 of the fastener 10 to stabilize the bolt 20 and therefore hold it perpendicular to the individual sign letter 135 and the stationary support structure 140. In this embodiment, the threaded stop nut 71 further functions to space the individual sign letters 135 and 136 from the stationary support structure 140. Another example of this embodiment is shown in FIG. 3, wherein the individual sign letters 136 and 137, specifically the letters “B” and “C” in the drawing, are secured to the face of the stationary support structure 140 such that no part of any fastener 10 is visible on the face of the individual sign letters 136 and 137.

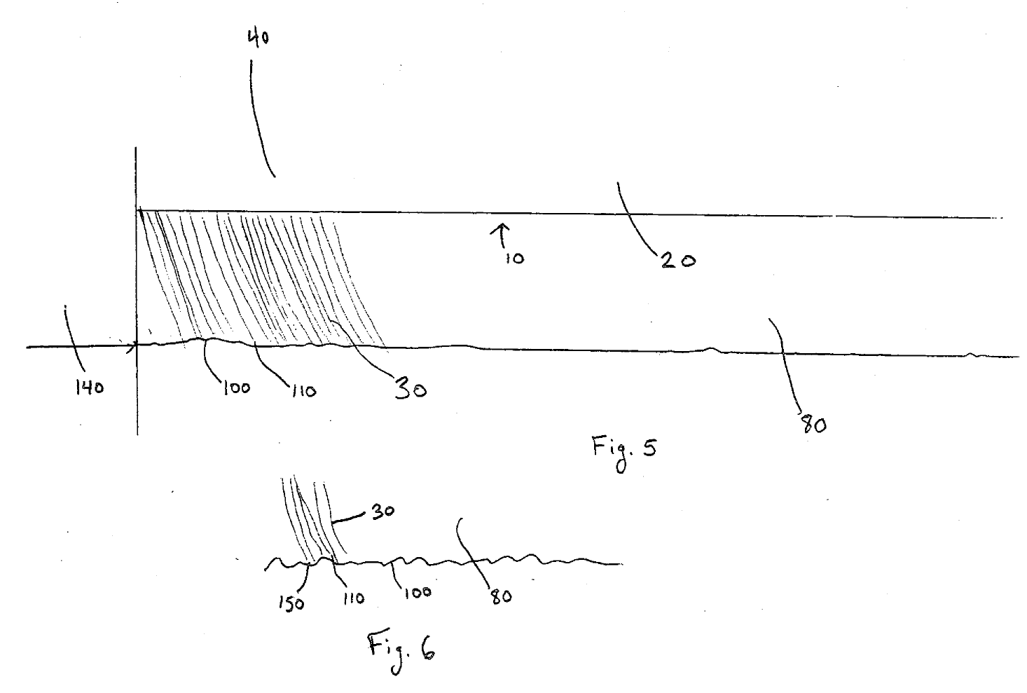

In yet another embodiment of the present invention, which is shown in FIG. 5, two fasteners 10 are used to secure a box member 145 having an interior surface 146 housing a fluorescent neon tubing sign 147 to a stationary support structure 140′ having an outer surface 141. Each fastener 10 includes two threaded stop nuts, a first threaded stop nut 72 and a second threaded stop nut 73. The fastener 10 is securably inserted into a hole in the stationary support structure 140 such that first section 60 of the fastener 10 extends away from the structure 140 and past the outer surface 141. The box member 145 is loaded onto the fasteners 10 and secured to the structure 140 by the threaded stop nuts 72/73 of the fastener 10. In this arrangement, the first threaded stop nut 72 is secured within the structure 140 and is substantially flush with the outer surface 141 of the structure 140. The second threaded stop nut 73 is substantially flush with the interior surface 146 of the box member 145, and helps to hold the box member 145 to the structure 140.

In another embodiment of the invention, the nut 70 is threaded to the bolt 20, but no threaded stop nut 71 is used. In yet another embodiment of the invention, neither the nut 70 nor the threaded stop nut 71 is threaded onto the bolt 20. Therefore, the nut 70 and the threaded stop nut 71 are optional elements of the invention. Instead, either one or both is optionally included depending on the nature of the particular application for which the fastener 10 is to be used. The nut 70 may or may not be included, for example, when the object to be secured will be held onto fasteners 10 by gravity, such as when a heavy sign is to be displayed on an inclined face of a stationary support structure. The threaded stop nut 71 may or may not be included, for example, in applications in which an object is intended to contact the stationary support structure 140, such as when an engraved plate is to be secured within a recessed space on the face of a building or the base of a statue.

Although it is expected that most applications will entail securing an object by using multiple fasteners 10, such as is shown in FIG. 2, only a single fastener 10 might be all that is required for some applications. For example, a single fastener 10 could be used to attach a lightweight object to a stationary support structure, such as a house number to the exterior wall of a house or a small individual sign letter to the face of a building.

Since the fastener 10 will be used for a variety of purposes, it also necessarily will be fabricated in a variety of sizes and dimensions. For example, the fastener 10 when used to secure a small bookshelf to a wall, might be of an overall smaller size than would the fastener 10 used to secure a large sign to the face of a building. In addition to variation in overall size between fasteners 10, there may be variation between fasteners 10 with respect to individual elements of the fasteners 10. For example, one fastener 10 could differ from a second fastener 10 in number or thickness of flexibly firm bristles 30. In keeping with this example, this would be advantageous because fasteners 10 having fewer or thinner flexibly firm bristles 30 could be secured within a range of hole inner circumferences that is different from that which fasteners 10 having more or thicker flexibly firm bristles 30, thereby allowing the invention to be used with a wide range of inner hole circumferences.

This variation is not limited, however, to bristle number and thickness. Aspects of the invention such as length of the bolt 20, length of the threading portion 50 of the bolt 20, thickness of the bolt 20, width of the nut 70 and of the threaded stop nut 71, length of the bristles 30, flexibility of the bristles 30, spacing of the bristles 30, overall weight of the fastener 10, etc. also may vary among fasteners 10.

FIG. 6 depicts the second section 40 of the bolt 20 inserted into a hole 80 recessed into a stationary support structure 140 such that its plurality of flexibly firm bristles 30 extend entirely into the hole 80, with ends 110 of some of the flexibly firm bristles 30 in frictional contact with the inner surface 100 of the hole 80. All of the flexibly firm bristles 30 of FIG. 6 are shown flexed in a manner that causes them to become compressed between the inner surface 100 of the hole 80 and the second section 40 of the bolt 20 in a manner that aids in establishing fastener engagement. The combined gripping of the inner surface 100 of the hole 80 by the flexibly firm bristles 30 and the force of the compression of the flexibly firm bristles 30 and the inner surface 100 of the hole 80 effectively secure the fastener 10 firmly within the hole 80. To achieve proper gripping and compression of the flexibly firm bristles 30, the diameter of the fastener 10 must be larger than the inner diameter of the hole 80.

Shown in FIG. 7 is a close-up view of contact being made between the ends 110 of the flexibly firm bristles 30 and the inner surface 100 of the hole 80 of FIG. 6. When the second end 40 of the fastener 10 is inserted into the hole 80, the ends 110 of some of the flexibly firm bristles 30 wedge into surface crevices 150 that are present along the inner surface 100 of the hole 80, whereas all flexibly firm bristles 30 become compressed between the bolt 20 of the fastener 10 and the inner surface 100 of the hole 80.

It will be readily understood by those skilled in this field that the fastener 10 may be used in a variety of applications, particularly those where no backside attachment is possible. This description is not intended to limit the principle concept of the present invention. All equivalents are deemed to fall within the scope of this description of the invention.

What is claimed is:

1. A fastener to aid in securing an object to a support structure, wherein the support structure includes a hole having an inner surface for retaining the fastener therein, the fastener comprising:
a. a substantially linear primary attachment member including a first section and a second section, wherein the first section includes means to removably retain the attachment member in a selectable position; and
b. a plurality of flexibly firm bristles on a portion or all of the second section, wherein the flexibly firm bristles are flexible enough to flex and maintain contact with the inner surface of the hole when the fastener is inserted in the hole.

2. The fastener of claim 1 wherein the substantially linear member is a bolt.

3. The fastener of claim 1 wherein the means to removably retain is threading.

4. The fastener of claim 4 further comprising at least one threaded stop nut, wherein the at least one threaded stop nut is removably connectable to the threading of the substantially linear member.

5. The fastener of claim 1 wherein the substantially linear member and the plurality of flexibly firm bristles are fabricated of a non-metallic material.

6. The fastener of claim 5 wherein the non-metallic material is a plastic or a plastic composite.

7. The fastener of claim 1 wherein the substantially linear member and the plurality of flexibly firm bristles are fabricated of a metal or a metal alloy.

8. The fastener of claim 7 wherein the metal alloy is stainless steel.

9. The fastener of claim 1 wherein the flexibly firm bristles are of sufficient length to ensure contact with the inner surfaces of hole of varied inner circumferences.
